(19) United States
(12) Patent Application Publication
(10) Pub. No.: US 2026/0290698 A1
(43) Pub. Date: Sep. 24, 2026

(54) MULTILAYER CERAMIC CAPACITOR

(71) Applicant: SAMSUNG ELECTRO-MECHANICS CO., LTD., Suwon-si (KR)

(72) Inventors: Myunghyun Jo, Suwon-si (KR); Ban Seok Choi, Suwon-si (KR); Eunchae Park, Suwon-si (KR); Geumhee Yun, Suwon-si (KR)

(73) Assignee: SAMSUNG ELECTRO-MECHANICS CO., LTD., Suwon-si (KR)

(21) Appl. No.: 19/274,303

(22) Filed: Jul. 18, 2025

(30) Foreign Application Priority Data
Mar. 21, 2025 (KR) 10-2025-0036730

(51) Int. Cl. H01G 4/30; H01G 4/012; H01G 4/12

(52) U.S. Cl. CPC H01G 4/30; H01G 4/012; H01G 4/1209

(57) ABSTRACT

A multilayer ceramic capacitor may include a ceramic main body including a dielectric layer, a first internal electrode and a second internal electrode stacked with the dielectric layer therebetween, and a cover layer on the first internal electrode and the second internal electrode; and a first external electrode disposed outside the ceramic main body and connected to the first internal electrode, wherein internal electrode connectivity to the first internal electrode and the second internal electrode is 85% or higher, respectively, and the ceramic main body may include an active region in which the first internal electrode and the second internal electrode overlap, and a first margin region; the ceramic main body satisfies the following Condition Equation 1 and Condition Equation 2. The Condition Equation 1 is 8.6%≤(LM3+LM4)/WC≤10%, and the Condition Equation 2 is 30°≤θ≤45°.

### CROSS-REFERENCE TO RELATED APPLICATION

This application claims priority to and the benefit of Korean Patent Application No. 10-2025-0036730 filed with the Korean Intellectual Property Office on Mar. 21, 2025, the entire contents of which are incorporated herein by reference.

### BACKGROUND

### (a) Technical Field

The present disclosure concerns a multilayer ceramic capacitor.

### (b) Description of the Related Art

A multilayer ceramic capacitor (MLCC: Multi-Layered Ceramic Capacitor), one of multilayer electronic components, is a chip-typed capacitor mounted on the printed circuit board (PCB) of various electronic products such as imaging devices (OLED, LED), computers, smartphones, and mobile phones to store charge and then discharge it if necessary.

These multilayer ceramic capacitors may be used as components of various electronic devices due to advantages of small size, high capacity, and convenience of mount. Recently, with the convergence of IT and electronics technologies, thin film, high capacity, and high reliability are required for multilayer ceramic capacitors. However, as multilayer ceramic capacitors become thinner and higher in capacity, breakdown voltage (BDV) and average time to failure (MTTF) decrease, which may degrade the reliability of multilayer ceramic capacitors. Therefore, a solution for improving this is needed.

### SUMMARY

The present disclosure attempts to provide a multilayer ceramic capacitor capable of improving breakdown voltage and average time to failure.

A multilayer ceramic capacitor according to an aspect includes: a ceramic main body having a first surface and a second surface facing each other in a first direction, a third surface and a fourth surface facing each other in a second direction and connecting the first surface and the second surface, a fifth surface and a sixth surface facing each other in a third direction and connecting the first surface and the second surface, the ceramic main body including a dielectric layer, a first internal electrode and a second internal electrode stacked in the third direction, the dielectric layer interposing the first internal electrode and the second internal electrode, and a cover layer positioned on the first internal electrode and the second internal electrode; a first external electrode disposed outside the ceramic main body and connected to the first internal electrode; and a second external electrode disposed outside the ceramic main body and connected to the second internal electrode, wherein an internal electrode connectivity of each of the first internal electrode and the second internal electrode is 85% or higher, and the ceramic main body may include an active region in which the first internal electrode and the second internal electrode overlap, and a margin region that includes a first margin region disposed between the first internal electrode and the third surface, and a second margin region disposed between the first internal electrode and the fourth surface. The ceramic main body satisfies the following Condition Equation 1 and Condition Equation 2. The Condition Equation 1 is 8.6%≤(LM3+LM4)/WC≤10%, where, LM3: a length of first margin region, LM4: a length of second margin region, WC: a width of ceramic main body. And the Condition Equation 2 is 30°≤θ≤45°, where θ: a sinking angle of the cover layer.

The average size difference of dielectric grain sizes in the ceramic main body may be 2% to 10%.

The average size difference of dielectric grain size may be calculated by the following Relationship Equation 1. Relationship Equation 1 states that DG=|(GC−GD)/GC|×100(%). Here, DG is the average size difference of dielectric grain sizes, GC is an average grain size of dielectric in the center portion of ceramic main body, and GD is an average grain size of dielectric in the margin region.

The internal electrode connectivity of the first internal electrode may be calculated by the following Relationship Equation 2. Relationship Equation 2 states that

$$EC = ( ( {\sum }_{i = 1}^{n} ti ) / TT ) \times 100 ( \% ) .$$

Here, EC is the internal electrode connectivity of the first internal electrode, n is a number of parts to which the first internal electrode is actually connected, ti is a length of each part to which the first internal electrode is actually connected, and TT is a total length of the first internal electrode.

The cover layer may include a center region positioned on the active region and a side region positioned outside the center region, and the sinking angle may be an angle between an extension of the surface of the center region and the surface of the side region.

The side region may be positioned on the margin region.

The center region may not overlap the margin region, and the side regions may not overlap the active region.

The first surface may contact the first external electrode, and the second surface may contact the second external electrode, and the side region may include a first side region extended from the center region to the first surface, and a second side region extended from the center region to the second surface.

The sinking angle may include a first sinking angle between the extension of the surface of the center region and a surface of the first side region and a second sinking angle between the extension of the surface of the center region and a surface of the second side region, and both the first sinking angle and the second sinking angle may satisfy the Condition Equation 2.

The first internal electrode includes a plurality of first internal electrodes, and the second internal electrode includes a plurality of second internal electrodes, and a length of the active region may be a maximum value among lengths of the portions where the plurality of first internal electrodes and the plurality of second internal electrodes overlap.

The first internal electrode includes a plurality of first internal electrodes, and the second internal electrode includes a plurality of second internal electrodes, and a length of the active region may be a minimum value among lengths of the portions where the plurality of first internal electrodes and the plurality of second internal electrodes overlap.

The first internal electrode includes a plurality of first internal electrodes, and the second internal electrode includes a plurality of second internal electrodes, and a length of the active region may be an arithmetic average of at least two lengths among lengths of the portions where the plurality of first internal electrodes and the plurality of second internal electrodes overlap.

A length of the first margin region may be a maximum value among lengths measured from the active region to the first external electrode in a direction parallel to the first internal electrode, and a length of the second margin region may be a maximum value among lengths measured from the active region to the second external electrode in a direction parallel to the first internal electrode.

A length of the first margin region may be a minimum value among lengths measured from the active region to the first external electrode in a direction parallel to the first internal electrode, and a length of the second margin region may be a minimum value among lengths measured from the active region to the second external electrode in a direction parallel to the first internal electrode.

The length of the first margin region may be an arithmetic average of at least two of lengths measured from the active region to the first external electrode in a direction parallel to the first internal electrode, and the length of the second margin region may be an arithmetic average of at least two of length measured from the active region to the second external electrode in a direction parallel to the first internal electrode.

A method of manufacturing a multilayer ceramic capacitor according to an aspect includes laminating dielectric green sheets to form a laminate, wherein the dielectric green sheets include a ceramic and polyvinyl butyral, and the polyvinyl butyral has a glass transition temperature of 80° C. or more and 90° C. or less, and a polymerization degree of 1,300 or more and 3,000 or less.

The dielectric green sheets may include the polyvinyl butyral in an amount of 10 wt % or more and 30 wt % or less, based on a total weight of the ceramic.

The method may further include pressing the laminate to form the ceramic main body.

According to at least one multilayer ceramic capacitor of the embodiments, the breakdown voltage (BDV) and the average time to failure (MTTF) can be improved by controlling the margin length ratio, the sink angle of the upper protective layer, and the internal electrode connectivity.

### BRIEF DESCRIPTION OF THE DRAWINGS

FIG. 1 is a perspective view illustrating a multilayer ceramic capacitor according to an embodiment.

FIG. 2 is a perspective view illustrating a ceramic main body separated from the multilayer ceramic capacitor of FIG. 1.

FIG. 3 is a cross-sectional view taken along the III-III′ line of FIG. 1.

FIG. 4 is a cross-sectional view taken along line IV-IV′ of FIG. 2.

FIG. 5 is a cross-sectional view taken along line V-V′ of FIG. 2.

FIG. 6 is an enlarged drawing of the SC1 portion of FIG. 4.

FIG. 7 is an enlarged drawing of the SC2 portion of FIG. 4.

FIG. 8 is an enlarged view of the first internal electrode.

### DETAILED DESCRIPTION

Hereinafter, an embodiment of the present disclosure will be described in detail with reference to the accompanying drawing so that a person of ordinary skill in the art to which the present disclosure belongs can easily carry out the present disclosure. In order to clearly explain the present disclosure, parts that are not relevant to the description are omitted, and identical or similar components are assigned the same reference numerals throughout the specification. Additionally, some components in the accompanying drawing are exaggerated, omitted, or schematically depicted, and the size of each component does not fully reflect the actual size.

The accompanying drawings are provided only to facilitate easy understanding of the embodiments disclosed in this specification, and it should be understood that the technical ideas disclosed in this specification are not limited by the accompanying drawings, and include all modifications, equivalents, and substitutes included in the spirit and technical scope of the present disclosure.

Terms including ordinal numbers, such as first, second, etc., may be used to describe elements of various configurations, but the components are not limited by such terms. Such terms may be used to distinguish one component from another.

When a part such as a layer, film, region, or plate is referred to as being “on” another part, it includes being directly on another part or other part being present therebetween. In contrast, when an element is referred to as being “directly on” another element, there are no intervening elements present. In addition, being “on” or “above” a reference element means being positioned on or below the reference element, and does not necessarily mean being positioned “above” or “on” in a direction opposite to gravity.

Throughout the specification, terms such as “includes” or “has” should be understood to specify the presence of a feature, number, step, operation, component, part, or combination thereof described in the specification, but not to exclude in advance the possibility of the presence or addition of one or more other features, numbers, steps, operations, components, parts, or combinations thereof. Therefore, when describing that a part “includes” a component, this does not mean that it excludes other components, unless otherwise specifically stated, but rather that it may include other components.

Throughout the specification, when referring to “a plane view”, it means that a target portion is viewed from above, and when referring to “a cross-section view”, it means that a cross section of the target portion cut vertically is viewed from a side. When the specification says ‘connected’, it means not only that two or more components are directly connected, but also that two or more components are indirectly connected by other components, physically or electrically connected, or incorporated as one piece while referring to different names according to positions and functions.

When describing a multilayer ceramic capacitor in this specification, a direction in which main components of the multilayer ceramic capacitor are stacked is defined as ‘stacking direction’, but it may be referred to ‘thickness direction’. Also, a direction parallel to a plane perpendicular to the stacking direction may be defined as the ‘planar direction’.

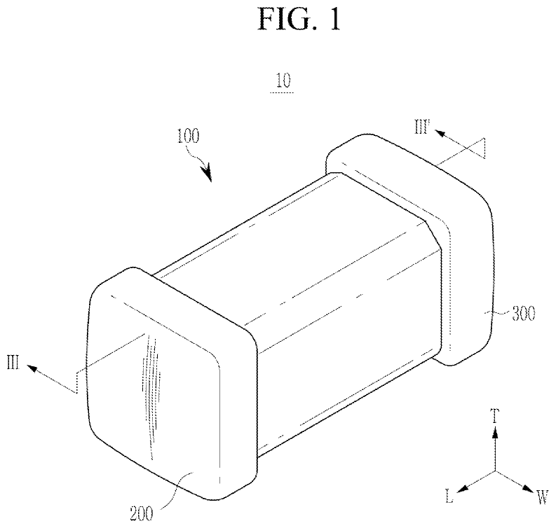

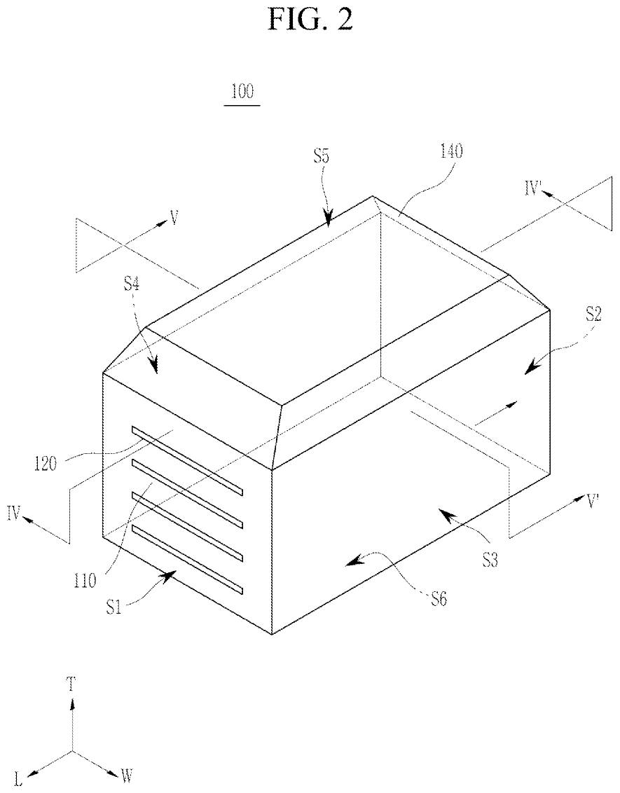

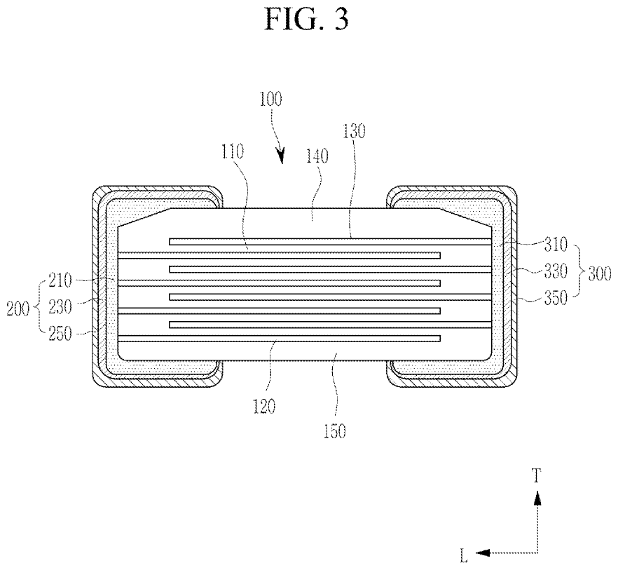

FIG. 1 is a perspective view illustrating a multilayer ceramic capacitor 10 according to an embodiment. FIG. 2 is a perspective view illustrating a ceramic main body 100 separated from the multilayer ceramic capacitor 10 of FIG. 1. FIG. 3 is a cross-sectional view taken along the III-III′ line of FIG. 1.

Referring to FIG. 1, FIG. 2, and FIG. 3, a multilayer ceramic capacitor 10 according to the present embodiment includes a ceramic main body 100, a first external electrode 200, and a second external electrode 300.

First, defining directions to clearly explain the present embodiment, the L-axis, W-axis, and T-axis shown in the drawings indicate a length direction, a width direction, and a thickness direction of the ceramic main body 100, respectively.

The thickness direction (T-axis direction) may be a direction perpendicular to the widest surface (main surface) of components having a sheet-shape. For example, the thickness direction (T-axis direction) may be used as the same concept as the direction in which the components of the ceramic main body 100 are laminated.

The length direction (L-axis direction) is a direction parallel to the widest surface (main surface) of components having a sheet shape, and may be a direction intersecting (or perpendicular to) the thickness direction (T-axis direction). For example, the length direction (L-axis direction) may be a direction in which the first external electrode 200 and the second external electrode 300 face each other.

The width direction (W-axis direction) is a direction parallel to the widest surface (main surface) of components having a sheet shape, and may be a direction intersecting (or is perpendicular to) the thickness direction (T-axis direction) and the length direction (L-axis direction) simultaneously.

The ceramic main body 100 may be made in a roughly hexahedral shape, but not limited thereto. Due to shrinkage during sintering, the ceramic main body 100 may have a shape that is not perfectly hexahedral but substantially hexahedral. For example, the ceramic main body 100 has a roughly rectangular hexahedral shape, but some portions corresponding to corners or vertices may have rounded shapes, or an upper outer portion is inclined downward.

In the present embodiment, for convenience of explanation, the surfaces facing each other in the length direction (L-axis direction) of the ceramic main body 100 are defined as a first surface S1 and a second surface S2. Also, the surfaces connecting the first surface S1 and the second surface S2 while facing each other in the width direction (W-axis direction) of the ceramic main body 100 are defined as a third surface S3 and a fourth surface S4. Additionally, the surfaces connecting the first surface S1 and the second surface S2 while facing each other in the thickness direction (T-axis direction) of the ceramic main body 100 are defined as a fifth surface S5 and a sixth surface S6.

Therefore, the first direction in which the first surface S1 and the second surface S2 face each other may be the length direction (L-axis direction). Additionally, the second direction and third direction, which are perpendicular to the first direction and perpendicular to each other, may be the thickness direction (T-axis direction) and the width direction (W-axis direction), respectively. Also, in another example, the first direction in which the first surface S1 and the second surface S2 face each other may be the length direction (L-axis direction), and the second direction and the third direction, which are perpendicular to the first direction and perpendicular to each other, may be the width direction (W-axis direction) and the thickness direction (T-axis direction), respectively.

Additionally, in the following, if necessary, the fifth side S5 may be referred to as a upper surface, and the sixth side S6 may be referred to as a lower surface. The upper surface may be a portion to which pressure is applied during sintering the ceramic main body 100.

With an optical microscope photograph or scanning electron microscope (SEM) photograph taken for a length direction (L-axis direction)-thickness direction (T-axis direction) cross-section of a center portion in the width direction (W-axis direction) of the ceramic main body 100 as a reference, the length of the ceramic main body 100 may mean a maximum value among the lengths of a plurality of line segments parallel to the length direction (L-axis direction) and connecting the two outermost boundary lines facing in the length direction (L-axis direction) of the ceramic main body 100 shown in the aforementioned cross-section photograph. Meanwhile, the length of the ceramic main body 100 may mean a minimum value among the lengths of a plurality of line segments parallel to the length direction (L-axis direction) while connecting two outermost boundary lines facing in the length direction (L-axis direction) of the ceramic main body 100 shown in the aforementioned cross-section photograph. On the other hand, the length of the ceramic main body 100 may mean an arithmetic average value of the lengths of at least two line segments among the plurality of line segments parallel to the length direction (L-axis direction) while connecting the two outermost boundary lines facing in the length direction (L-axis direction) of the ceramic main body 100 shown in the aforementioned cross-section photograph.

With an optical microscope photograph or scanning electron microscope (SEM) photograph taken for a length direction (L-axis direction)-thickness direction (T-axis direction) cross-section of a center portion of the width direction (W-axis direction) of the ceramic main body 100 as a reference, the thickness of the ceramic main body 100 may mean a maximum value among the lengths of a plurality of line segments parallel to the thickness direction (T-axis direction) and connecting the two outermost boundary lines facing in the thickness direction (T-axis direction) of the ceramic main body 100 shown in the aforementioned cross-section photograph. Meanwhile, the thickness of the ceramic main body 100 may mean a minimum value among the lengths of a plurality of line segments parallel to the thickness direction (T-axis direction) while connecting two outermost boundary lines facing in the thickness direction (T-axis direction) of the ceramic main body 100 shown in the aforementioned cross-section photograph. On the other hand, the thickness of the ceramic main body 100 may mean an arithmetic average value of the lengths of at least two line segments among the plurality of line segments parallel to the thickness direction (T-axis direction) while connecting the two outermost boundary lines facing in the thickness direction (T-axis direction) of the ceramic main body 100 shown in the aforementioned cross-section photograph.

With an optical microscope photograph or scanning electron microscope (SEM) photograph taken for a length direction (L-axis direction)-width direction (W-axis direction) cross-section of a center portion of the thickness direction (T-axis direction) of the ceramic main body 100 as a reference, the width of the ceramic main body 100 may mean a maximum value among the lengths of a plurality of line segments parallel to the width direction (W-axis direction) and connecting the two outermost boundary lines facing in the width direction (W-axis direction) of the ceramic main body 100 shown in the aforementioned cross-section photograph. Meanwhile, the width of the ceramic main body 100 may mean a minimum value among the lengths of a plurality of line segments parallel to the width direction (W-axis direction) while connecting two outermost boundary lines facing in the width direction (W-axis direction) of the ceramic main body 100 shown in the aforementioned cross-section photograph. On the other hand, the width of the ceramic main body 100 may mean an arithmetic average value of the lengths of at least two line segments among the plurality of line segments parallel to the width direction (W-axis direction) while connecting the two outermost boundary lines facing in the width direction (W-axis direction) of the ceramic main body 100 shown in the aforementioned cross-section photograph.

Meanwhile, each of the length, width, and thickness of the above-mentioned ceramic main body 100 may be measured using the micrometer measurement method. The micrometer measurement method may be performed by setting a zero point with a micrometer with Gage R&R (Repeatability and Reproducibility) undergone, inserting the ceramic main body according to the present embodiment between the tips of the micrometer, and turning the measurement lever of the micrometer. Each of the length, width, and thickness of the ceramic main body measured using the micrometer measurement method may mean a value measured once, or may mean an arithmetic average of values measured multiple times.

The ceramic main body 100 includes dielectric layers 110, a first internal electrode 120, a second internal electrode 130, a first cover layer 140, and a second cover layer 150.

The dielectric layers 110 may be stacked in the thickness direction (T-axis direction) of the ceramic main body 100. The boundary between a plurality of dielectric layers 110 may be unclear. That is, a plurality of dielectric layers 110 may be seen as a single structure. For example, the boundary between a plurality of dielectric layers 110 may be so unclear that it is difficult to identify unless using a scanning electron microscope (SEM).

The dielectric layer 110 may include a ceramic material with a high dielectric constant. For example, the ceramic material may include a dielectric ceramic containing components such as BaTiO₃, CaTiO₃, SrTiO₃, or CaZrO₃. In addition, these components may further include auxiliary components such as manganese (Mn) compound, iron (Fe) compound, chromium (Cr) compound, cobalt (Co) compound, and nickel (Ni) compound. For example, the dielectric layer 110 may be (Ba₁₋ₓCaₓ)TiO₃, Ba(Ti_{1-y}Ca_{y})O₃, (Ba₁₋ₓCaₓ) (Ti_{1-y}Zr_{y})O₃ or Ba(Ti_{1-y}Zr_{y})O₃ that calcium (Ca), zirconium (Zr), and the like is partially dissolved in BaTiO₃, but not limited thereto.

Also, the dielectric layer 110 may further include at least one of ceramic additive, organic solvent, plasticizer, a binder, and dispersant. For example, the ceramic additive may include a transition metal oxide, a transition metal carbide, a rare-earth element, magnesium (Mg), or aluminum (Al).

Additionally, the slurry for forming the dielectric layer 110 may include a binder. If a binder is included in the slurry, plasticity or shape retention properties may be imparted. Since the binder disappears during the sintering process due to decomposition, etc., it may not remain in the dielectric layer 110 after sintering.

The first internal electrode 120 and the second internal electrode 130 may be alternately stacked with the dielectric layer 110 therebetween. Therefore, a structure of ‘first internal electrode/dielectric layer/second internal electrode/dielectric layer’ may be repeatedly arranged inside the ceramic main body 100. For example, the internal electrode closest to the fifth side S5 of the ceramic main body 100 may be the first internal electrode 120, and the internal electrode closest to the sixth side S6 may be the second internal electrode 130. For another example, the internal electrode closest to the fifth side S5 of the ceramic main body 100 may be the second internal electrode 130, and the internal electrode closest to the sixth side S6 may be the first internal electrode 120.

The first internal electrode 120 and the second internal electrode 130 have different polarities. The first internal electrode 120 and the second internal electrode 130 may be electrically insulated from each other by the dielectric layer 110 positioned therebetween.

The first internal electrode 120 and the second internal electrode 130 may be arranged along the length direction (L-axis direction) with the dielectric layer 110 therebetween. The first internal electrode 120 and the second internal electrode 130 may be arranged to be staggered with each other in the length direction (L-axis direction). Therefore, the first internal electrode 120 and the second internal electrode 130 are arranged so that some portions overlap, and some portions do not overlap in the thickness direction (T-axis direction).

One end of the first internal electrode 120 may be exposed to the first surface S1 of the ceramic main body 100, and one end of the second internal electrode 130 may be exposed to the second surface S2 of the ceramic main body 100. One end of the first internal electrode 120 may be exposed to the first surface S1 of the ceramic main body 100 to be electrically connected to the first external electrode 200. One end of the second internal electrode 130 may be exposed to the second surface S2 of the ceramic main body 100 to be electrically connected to the second external electrode 300.

For example, the first internal electrode 120 and the second internal electrode 130 may be formed by printing conductive paste on the surface of the dielectric layer 110. At this time, the conductive paste may contain conductive metal. For example, the internal electrode may be formed by printing a conductive paste containing nickel (Ni) or nickel (Ni) alloy on a surface of a dielectric green sheet using screen printing method or gravure printing method. However, the method of forming the first internal electrode 120 and the second internal electrode 130 is not limited to the above-mentioned examples.

The average thickness of the first internal electrode 120 and the second internal electrode 130 may be, for example, approximately 0.1 μm or more and 2 μm or less. With 10,000 times magnified scanning electron microscope (SEM) photograph taken for a length direction (L-axis direction)-thickness direction (T-axis direction) cross-section of the width direction (W-axis direction) center portion of the ceramic main body 100 as a reference, the average thickness of the internal electrode may be an arithmetic average of the values obtained by measuring the thickness of one internal electrode shown in the aforementioned cross-section photograph at 30 points with equal spacing in the length direction (L-axis direction).

When voltage is applied to the first external electrode 200 and the second external electrode 300, charges are accumulated between the first internal electrode 120 and the second internal electrode 130 adjacent to each other. That is, a capacitance may be obtained between the first internal electrode 120 electrically connected to the first external electrode 200 and the second internal electrode 130 electrically connected to the second external electrode 300. The capacitance of the multilayer ceramic capacitor 10 is proportional to the area that the first internal electrode 120 and the second internal electrode 130 overlap each other.

The first cover layer 140 may be placed over the internal electrode (hereinafter, referred to as the ‘uppermost internal electrode’) positioned at the uppermost with respect to the thickness direction (T-axis direction) among the internal electrodes. The second cover layer 150 may be placed under the internal electrode (hereinafter, referred to as the ‘lowest internal electrode’) positioned at the lowermost with respect to the thickness direction (T-axis direction) among the internal electrodes.

The first cover layer 140 and the second cover layer 150 may prevent the first internal electrode 120 and the second internal electrode 130 from being damaged by physical or chemical stress.

The first external electrode 200 and the second external electrode 300 are disposed outside the ceramic main body 100. The first external electrode 200 may be disposed on the first surface S1 of the ceramic main body 100. The first external electrode 200, which is arranged on the first surface S1 of the ceramic main body 100, may extend to the third surface S3, the fourth surface S4, the fifth surface S5, and the sixth surface S6. The second external electrode 300 may be disposed on the second surface S2. The second external electrode 300, which is arranged on the second surface S2 of the ceramic main body 100, may extend to the third surface S3, the fourth surface S4, the fifth surface S5, and the sixth surface S6. In another embodiment, the first external electrode 200 and the second external electrode 300 may extend to a portion of at least one of the fifth surface S5 and the sixth surface S6.

The first external electrode 200 may include a first electrode layer 210 and a first conductive resin layer 230. The second external electrode 300 may include a second electrode layer 310 and a second conductive resin layer 330.

The first electrode layer 210 and the second electrode layer 310 may include conductive metal and glass.

For example, the first electrode layer 210 and the second electrode layer 310 may include a conductive metal such as copper (Cu), a copper (Cu) alloy, nickel (Ni), silver (Ag), palladium (Pd), gold (Au), platinum (Pt), tin (Sn), tungsten (W), titanium (Ti), lead (Pb), an alloy thereof, or a combination thereof.

For example, the first electrode layer 210 and the second electrode layer 310 may include one or more oxide compositions selected from the group consisting of silicon oxide, boron oxide, aluminum oxide, transition metal oxide, alkali metal oxide, and alkaline-earth metal oxide as the glass. The transition metal may include one or more selected from the group consisting of zinc (Zn), titanium (Ti), copper (Cu), vanadium (V), manganese (Mn), iron (Fe), and nickel (Ni). The alkali metal may include one or more selected from the group consisting of lithium (Li), sodium (Na), and potassium (K). The alkali earth metal may include one or more selected from the group consisting of magnesium (Mg), calcium (Ca), strontium (Sr), and barium (Ba).

The first conductive resin layer 230 and the second conductive resin layer 330 may include resin and conductive metal.

The resin included in the first conductive resin layer 230 and the second conductive resin layer 330 is not particularly limited as long as it has bonding properties and impact absorption properties and can be mixed with conductive metal powder to manufacture a paste. For example, the first conductive resin layer 230 and the second conductive resin layer 330 may include phenol resin, acrylic resin, silicone resin, epoxy resin, or polyimide resin.

The conductive metal included in the first conductive resin layer 230 plays a role in electrically connecting the first electrode layer 210 and the first conductive resin layer 230, and the conductive metal included in the conductive resin layer 330 plays a role in electrically connecting the second electrode layer 310 and second conductive resin layer 330. The conductive metal included in the first conductive resin layer 230 and the second conductive resin layer 330 may have a spherical shape, a flake shape, or a combination thereof.

The first external electrode 200 may include a first plating layer 250 positioned outside the first conductive resin layer 230. That is, the first conductive resin layer 230 may have a portion positioned between the first electrode layer 210 and the first plating layer 250. The second external electrode 300 may include a second plating layer 350 positioned outside the second conductive resin layer 330. That is, the second conductive resin layer 330 may have a portion positioned between the second electrode layer 310 and the second plating layer 350.

The first plating layer 250 and the second plating layer 350 may contain nickel (Ni), copper (Cu), tin (Sn), palladium (Pd), platinum (Pt), gold (Au), silver (Ag), tungsten (W), titanium (Ti), or lead (Pb), alone or as an alloy thereof. For example, the first plating layer 250 and the second plating layer 350 may be in a form in which a nickel (Ni) plating layer and a tin (Sn) plating layer are sequentially laminated, or may be in a form in which a tin (Sn) plating layer, a nickel (Ni) plating layer, and a tin (Sn) plating layer are sequentially laminated. Also, the first plating layer 250 and the second plating layer 350 may include a plurality of nickel (Ni) plating layers and/or a plurality of tin (Sn) plating layers.

The first plating layer 250 and the second plating layer 350 can improve the mountability on the substrate, structural reliability, durability, heat resistance, and equivalent series resistance (ESR) of the multilayer ceramic capacitor 10.

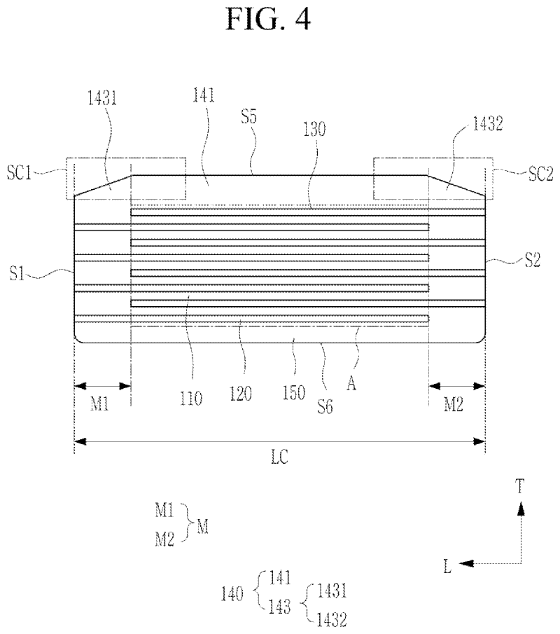

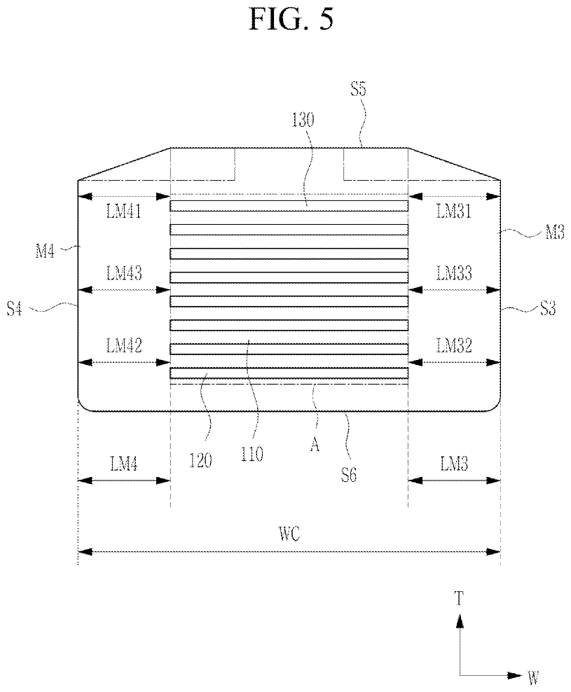

FIG. 4 is a cross-sectional view taken along line IV-IV′ of FIG. 2. FIG. 5 is a cross-sectional view taken along line V-V′ of FIG. 2.

If looking at the ceramic main body 100 from another side referring to FIG. 4 and FIG. 5, the ceramic main body 100 includes an active region (A) and a margin region (M). The active region (A) is a region where a plurality of first internal electrodes 120 and second internal electrodes 130 overlap each other along the thickness direction (T-axis direction). The active region (A) is the portion of the ceramic main body 100 where charge accumulates. The margin region (M) is a region between the active region (A) and an end surface of the ceramic main body 100. That is, the margin region (M) includes the third margin region M1, which is a region between the active region (A) and the first surface S1 of the ceramic main body 100, and the fourth margin region M2, which is a region between the active region (A) and the second surface S2 of the ceramic main body 100. Additionally, the margin region (M) includes a first margin region M3, which is a region between the active region (A) and the third surface S3 of the ceramic main body 100, and a second margin region M4, which is a region between the active region (A) and the fourth surface S4 of the ceramic main body 100. In other words, the first margin region M3 is disposed between the first internal electrode 120 or second internal electrode 130 and the third surface S3, and the second margin region M4 is disposed between the first internal electrode 120 or second internal electrode 130 and the fourth surface S4. At this time, the third surface S3 and the fourth surface S4 correspond to an outer surface of the ceramic main body 100 with the width direction as a reference. The third surface S3 and the fourth surface S4 are surfaces facing opposite in the width direction of the ceramic main body 100. At least a part of the third surface S3 and the fourth surface S4 may be exposed to the outside not covered by the first external electrode 200 and the second external electrode 300.

The multilayer ceramic capacitor 10 is classified based on its length and width. Even in multilayer ceramic capacitors 10 having the same length or width, the capacitances may be different depending on the ratio of the active region (A) and margin region (M) of the ceramic main body 100. The multilayer ceramic capacitor 10 of the present embodiment may be formed so that the margin length with respect to the WT size of the ceramic main body 100 occupies a certain range of ratio. Specifically, the ratio of margin length to the WT size of the ceramic main body 100 (hereinafter, “margin length ratio”) may be 8.6% or more and 10% or less. At this time, the width (WC), the length LM3 of the first margin region, and the length LM4 of the second margin region of the ceramic main body 100 may be measured based on an optical microscope photograph or scanning electron microscope (SEM) photograph of a thickness direction (T-axis direction)-width direction (W-axis direction) cross-section of a length direction (L-axis direction) center portion of the ceramic main body 100. Other methods and/or tools appreciated by one of ordinary skill in the art, even if not described in the present disclosure, may also be used. The length LM3 of the first margin region may be an arithmetic average of the length LM31 of the first margin region measured at the uppermost point of the first margin region M3, the length LM32 of the first margin region measured at the lowermost point of the first margin region M3, and the length LM33 of the first margin region measured at the middle point of the first margin region M3 in the aforementioned cross-section photograph of the ceramic main body 100, with the thickness direction (T-axis direction) as a reference. The length LM4 of the second margin region may be an arithmetic average of the length LM41 of the second margin region measured at the uppermost point of the second margin region M4, the length LM42 of the second margin region measured at the lowermost point of the second margin region M4, and the length LM43 of the second margin region measured at the middle point of the second margin region M4 in the aforementioned cross-section photograph of the ceramic main body 100, with the thickness direction (T-axis direction) as a reference. In other words, the following Condition Equation 1 may be satisfied with respect to the width of the ceramic main body.

$$8.6 \% \leq ( LM 3 + LM 4 ) / WC \leq 10 \% \qquad [ Condition Equation 1 ]$$

In here,
LM3: length of first margin region,
LM4: length of second margin region, and
WC: width of ceramic main body.

The active region (A) and margin region (M) are different in shrinkage rates when pressure is applied. That is, the active region (A) has shrinkage rate lower than that of the margin region (M) due to a high content of metallic material forming the first internal electrode 120 and the second internal electrode 130. Therefore, during sintering, the degree of shrinkage of the margin region (M) may be greater than the degree of shrinkage of the active region (A). As the margin region (M) shrinks more than the active region (A), the portion of the first cover layer 140 positioned above the margin region (M) may sink.

A length of the active region (A) may be a maximum value among lengths of the portions where the plurality of first internal electrodes and the plurality of second internal electrodes overlap. A length of the active region (A) may be a minimum value among lengths of the portions where the plurality of first internal electrodes and the plurality of second internal electrodes overlap. A length of the active region (A) may be an arithmetic average of at least two lengths among lengths of the portions where the plurality of first internal electrodes and the plurality of second internal electrodes overlap. The lengths of the portions where the plurality of first internal electrodes and the plurality of second internal electrodes overlap may be measured using scanning electron microscope (SEM). Other methods and/or tools appreciated by one of ordinary skill in the art, even if not described in the present disclosure, may also be used.

A length of the first margin region may be a maximum value among lengths measured from the active region to the first external electrode in a direction parallel to the first internal electrode, and a length of the second margin region may be a maximum value among lengths measured from the active region to the second external electrode in a direction parallel to the first internal electrode. A length of the first margin region may be a minimum value among lengths measured from the active region to the first external electrode in a direction parallel to the first internal electrode, and a length of the second margin region may be a minimum value among lengths measured from the active region to the second external electrode in a direction parallel to the first internal electrode. The length of the first margin region may be an arithmetic average of at least two of lengths measured from the active region to the first external electrode in a direction parallel to the first internal electrode, and the length of the second margin region may be an arithmetic average of at least two of length measured from the active region to the second external electrode in a direction parallel to the first internal electrode. The lengths measured from the active region to the external electrode may be measured using scanning electron microscope (SEM). Other methods and/or tools appreciated by one of ordinary skill in the art, even if not described in the present disclosure, may also be used.

Referring to FIG. 4, the first cover layer 140 of the present embodiment may be divided into a center region 141 and a side region 143.

The center region 141 is positioned in a center portion of the first cover layer 140. The center region 141 may be defined as a part overlapping the active region (A) in the thickness direction (T-axis direction). A surface F1 of the center region 141 may be roughly parallel to the first internal electrode 120 or the second internal electrode 130. That is, among the center region 141, a part exposed to the fifth surface S5 may be roughly parallel to the first internal electrode 120 or the second internal electrode 130. The center region 141 may have a portion overlapping the active region (A).

The side region 143 is positioned beside the center region 141. The side region 143 is formed at the edge of first cover layer 140. The side region 143 may be disposed to surround the center region 141. The side region 143 may have a portion overlapping the margin region (M) in the thickness direction (T-axis direction). The side region 143 may be defined as a portion having a sinking angle with respect to the center region 141. Referring to FIG. 3, the side region 143 may include a first side region 1431, which is a region between the center region 141 and the first surface S1, and a second side region 1432, which is a region between the center region 141 and the second surface S2. The first side region 1431 and the second side region 1432 may overlap the first margin region and the second margin region in the thickness direction (T-axis direction), respectively.

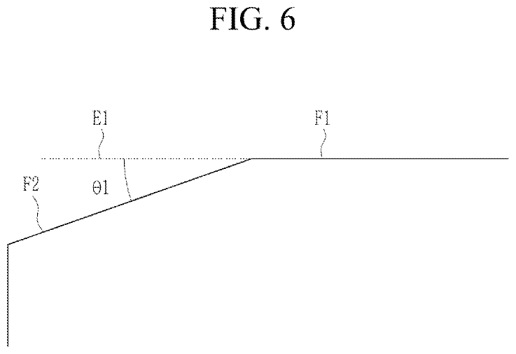

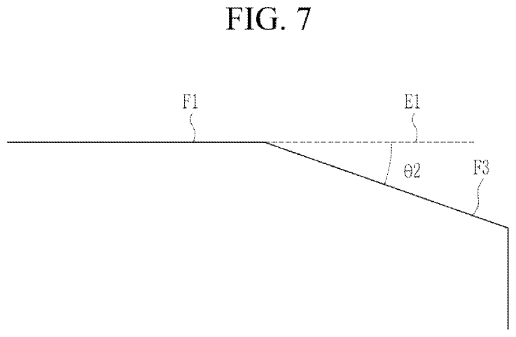

FIG. 6 is an enlarged drawing of the SC1 portion of FIG. 4. FIG. 7 is an enlarged drawing of the SC2 portion of FIG. 4.

Referring to FIG. 4, FIG. 6, and FIG. 7, a surface of the side region 143 is inclined with respect to a surface F1 of the center region 141. That is, the side region 143 may be formed such that the surfaces F2 and F3 make sinking angles with an imaginary extension line E1 extended from the surface F1 of center region 141. The sinking angle may be formed when the margin region shrinks more than the active region (A) during sintering.

The surface F1 of the center region 141 and the surface F2 of the first side region 1431 may form a first sinking angle θ1. The first sinking angle θ1 may be defined as an angle formed by the imaginary extension line E1 and the surface F2 of the first side region 1431. The surface F1 of the center region 141 and the surface F3 of the second side region 1432 may form a second sinking angle θ2. The second sinking angle θ2 may be defined as an angle formed by the imaginary extension line E1 and the surface F3 of the second side region 1432.

For example, the surface F2 of first side region 1431 may be defined as a line connecting an endpoint of the center region 141 and an endpoint of the first surface S1. At this time, the endpoint of the center region 141 may be defined as a point close to the first surface S1 among the points where the surface F1 of the center region 141 extended parallel to the first internal electrode 120 or the second internal electrode 130 begins to incline in a direction to the sixth surface S6, and the endpoint of the first surface S1 may be defined as a point where the first surface S1 extended in the thickness direction (T-axis direction) begins to incline in a direction to the second surface S2. Also, the surface F3 of the second side region 1432 may be defined as a line connecting the endpoint of the center region 141 and the endpoint of the second surface S2. At this time, the endpoint of the center region 141 may be defined as a point closer to the second surface S2 among the points where the surface F1 of the center region 141 extended parallel to the first internal electrode 120 or the second internal electrode 130 begins to incline in a direction to the sixth surface S6, and the endpoint of the second surface S2 may be defined as a point where the second surface S2 extended in the thickness direction (T-axis direction) begins to incline in a direction to the first surface S1.

In other words, the first sinking angle θ1 may mean an angle formed by the surface F2 of the first side region 1431 and the extension line of the uppermost internal electrode of the internal electrodes shown in the aforementioned cross-section photograph. In addition, the second sinking angle θ2 may mean an angle formed by the surface F3 of the second side region 1432 and the uppermost internal electrode of the internal electrodes shown in the aforementioned cross-section photograph. The sinking angle, the first sinking angle, and the second sinking angle may be measured using a microscope. Other methods and/or tools appreciated by one of ordinary skill in the art, even if not described in the present disclosure, may also be used.

For example, the first sinking angle θ1 and the second sinking angle θ2 may be greater than or equal to 30°, and less than or equal to 45°. That is, the first sinking angle θ1 and the second sinking angle θ2 may satisfy the following Condition Equation 2 and Condition Equation 3.

$$30 ° \leq θ1 \leq 45 ° \qquad [ Condition Equation 2 ]$$

θ1: first sinking angle of the first cover layer

$$30 ° \leq θ2 \leq 45 ° \qquad [ Condition Equation 3 ]$$

θ2: second sinking angle of the first cover layer

For example, the sinking angle may be expressed as an average of ten values obtained by measuring the first sinking angle θ1 and the second sinking angle θ2 for five multilayer ceramic capacitors of the present embodiment.

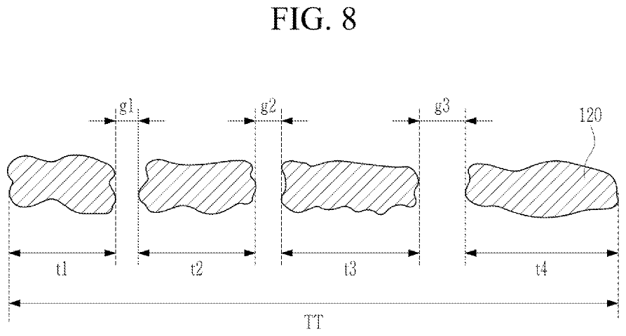

FIG. 8 is an enlarged view of the first internal electrode.

Referring to FIG. 8, the first internal electrode 120 and the second internal electrode 130 of the present embodiment may have internal electrode connectivity of 85% or more and 95% or less. More preferably, the internal electrode connectivity of the first internal electrode 120 and the second internal electrode 130 can be 88% or more and 95% or less. The internal electrode connectivity may be defined as a ratio of a length of the portion that the internal electrode is actually formed to an total length of the internal electrode. The total length of the internal electrode and length of the portion that the internal electrode is actually formed may be measured using an optical image obtained by scanning a cross-section of a multilayer ceramic capacitor. For example, from an image obtained by scanning a length direction (L-axis direction) cross-section of a ceramic body cut at the center portion of the width direction (W-axis direction) of a ceramic body, the ratio of a length of the portion that the internal electrode is actually formed to an total length of the internal electrode can be measured. Specifically, when the total length of the internal electrode including the pores is TT, and the lengths of the length of the portion that the internal electrode is actually formed are t1, t2, t3, . . . , tn, the internal electrode connectivity may be expressed as (t1, t2, t3, . . . , tn)/TT. In FIG. 8, the portions where internal electrodes are formed are depicted as t1, t2, t3, and t4, but the number of portion where the internal electrodes are actually formed is not particularly limited.

As an example, the internal electrode connectivity may be measured using a scanning electron microscope (SEM) photograph of a length direction (L direction)-thickness direction (T direction) cross-section of the center portion in the width direction (W direction) of the ceramic main body 100. Other methods and/or tools appreciated by one of ordinary skill in the art, even if not described in the present disclosure, may also be used. Referring to FIG. 8, in the aforementioned cross-section photograph, the ratio of the length (t1, t2, t3, t4) of the portion where the internal electrode is actually connected to the internal electrode total length (TT) can be measured. At this time, the internal electrode connectivity may satisfy Relationship Equation 1 below.

$$EC = ( ( {\sum }_{i = 1}^{n} ti ) / TT ) \times 100 ( \% ) \qquad [ Relationship Equation 1 ]$$

In here,
EC: internal electrode connectivity
n: the number of portions where the internal electrode is actually connected
ti: length of each portion where the internal electrode is actually connected
TT: total length of internal electrode

From another perspective, the internal electrode connectivity may be expressed as a ratio of the total length of the internal electrode and subtraction the length of the portion where pores are formed from the total length of the internal electrode. Specifically, when the total length of the internal electrode including the pores is TT, and the lengths of the portions of the internal electrode where the pores are formed are g1, g2, g3, . . . , gm, the connectivity of the internal electrode may be expressed as (TT−g1−g2−gm)/TT. In FIG. 8, the portion where pores are formed are depicted as g1, g2, and g3, but the number of parts where pores are actually formed is not particularly limited.

Referring to FIG. 8, in the aforementioned cross-section photograph, the ratio of lengths g1, g2, and g3 of the portions where the pore is formed to the total length (TT) of the internal electrode may be measured. At this time, the internal electrode connectivity may satisfy Relationship Equation 2 below.

$$EC = ( ( TT - {\sum }_{j = 1}^{m} gj ) / TT ) \times 100 ( \% ) \qquad [ Relationship Equation 2 ]$$

In here,
EC: internal electrode connectivity
m: number of pores formed in the internal electrode
gj: length of each pore formed in the internal electrode
TT: total length of internal electrode

For example, to improve the reliability of data on internal electrode connectivity, the total internal electrode length (TT), the number of portions where the internal electrode is actually connected (n), and the length of each portions where the internal electrode is actually connected (ti) may be measured for at least five internal electrodes. Also, for at least five internal electrodes, the total internal electrode length (TT), the number of pores formed in the internal electrode (m), and the length of each pore formed in the internal electrode (gj) may be measured.

Hereinafter, a method of manufacturing a multilayer ceramic capacitor according to an embodiment is described.

First, dielectric paste for forming a plurality of dielectric green sheets is prepared. The dielectric paste may include ceramic powder, ceramic additive, organic solvent, plasticizer, dispersant, and binder.

For example, the ceramic powder may include a dielectric ceramic containing components such as BaTiO₃, CaTiO₃, SrTiO₃, or CaZrO₃. In addition, these components may further include auxiliary components such as Mn compound, Fe compound, Cr compound, Co compound, Ni compound, and the like. For example, BaTiO₃-based dielectric ceramics may include (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃, in which Ca, Zr, etc. are partially dissolved.

For example, the ceramic additive may include a transition metal oxide, a transition metal carbide, a rare-earth element, magnesium (Mg), aluminum (Al), and the like.

The organic solvent is not particularly limited and may include, for example, butylcarbitol, acetone, toluene, acetic acid ethyl, etc.

The binder may be PVB (Polyvinyl Butyral) binder with glass transition temperature (Tg) of 80° C. or higher and 90° C. or lower. For example, the binder may further include at least one of polyacrylic acid ester, polymethacrylic acid ester, polyvinyl alcohol, cellulose dielectric material, polyalkylene oxide, polyurethane, polyacetic acid vinyl, polyethylene, ethylene acetic acid vinyl copolymer, and polychloride vinyl. The dielectric paste of the present embodiment may contain a binder of 10 wt % to 30 wt % relative to the weight of the ceramic.

The dielectric paste may be provided through a crushing process so that the powders have uniform particles in an organic solvent. For example, ceramic powder, ceramic additive, organic solvent, plasticizer, dispersant, and binder are filled into a hollow cylindrical crush mill, and the powder may be crushed by torque generated when an impeller provided in the crush mill rotates at a constant speed. Additionally, a process for separating coarse particles may be performed, and a filtering process for removing foreign substances may be performed.

A plurality of dielectric green sheets of a sheet shape with a thickness of several μm are manufactured through a method such as a doctor blading or screen printing the dielectric material paste provided as described above.

For example, a dielectric green sheet may be manufactured by a method of applying dielectric paste on a film to a certain thickness, performing a filtering process, a drying process, and then removing the film.

A conductive paste layer is formed on a surface of some of the dielectric green sheets. The conductive paste layer may become the first internal electrode and the second internal electrode after sintering. The conductive paste layer may be formed by applying conductive paste containing a conductive metal to a surface of a dielectric green sheet using a method such as a doctor blade or screen printing. For example, the conductive metal may include metals such as Ni, Cu, Ag, Pd, or Au, or alloys thereof.

For example, the conductive paste layer may be applied on the dielectric green sheet in two patterns. The conductive paste may be applied to a first dielectric green sheet surface in a first pattern to form a first conductive paste layer. Also, the conductive paste may be applied to a second dielectric green sheet surface in a second pattern to form a second conductive paste layer.

A dielectric green sheet laminate is manufactured by laminating dielectric green sheets.

The first pattern and the second pattern may be aligned so that some of the first conductive paste layer and the second conductive paste layer overlap and some do not overlap when the first dielectric green sheet and the second dielectric green sheet are alternately laminated. The first conductive paste layer may become the first internal electrode after sintering, and the second conductive paste layer may become the second internal electrode after sintering.

Then, a dielectric green sheet laminate is manufactured by laminating dielectric green sheets. At this time, the first dielectric green sheets and the second dielectric green sheets are laminated so that the first conductive paste layer and the second conductive paste layer overlap, but at least some of them do not overlap.

A third dielectric green sheet where no conductive paste layer is formed is laminated on the first dielectric green sheet and under the second dielectric green sheet.

The dielectric green sheet laminate manufactured as described above is pressed. The pressure applied for pressing may vary depending on the composition of the dielectric green sheet or conductive paste, the size of the ceramic main body 100, and atmospheric conditions such as temperature. Before performing the pressing process, a simulation may be performed to determine the appropriate pressure. That is, by compressing the laminate with a pre-calculated pressure, it is possible to include PVB (Polyvinyl Butyral) binder, which has a glass transition temperature (Tg) of 80° C. or more and 90° C. or less and a polymerization degree of 1,300 or more and 3,000 or less, at 10 wt % or more and 30 wt % or less relative to the ceramic weight.

During the step of laminating or pressing the dielectric green sheet laminate, sink of the first cover layer may occur. At this time, if PVB (Polyvinyl Butyral) binder, which has a glass transition temperature (Tg) of 80° C. or more and 90° C. or less and a polymerization degree of 1,300 or more and 3,000 or less, is contained at 10 wt % or more and 30 wt % or less relatively to the ceramic weight, the sinking angles θ1 and θ2 of the first cover layer and the second cover layer 150 can be formed to be 30° or more and 45° or less.

Additionally, clumping and disconnection of the electrode may occur during the step of laminating or pressing the dielectric green sheet laminate. Accordingly, pores may be created within the internal electrode. At this time, if a PVB (Polyvinyl Butyral) binder, which has a glass transition temperature (Tg) of 70° C. or more and 90° C. or less and a polymerization degree of 1,300 or more and 3,000 or less, is contained at 10 wt % or more and 30 wt % or less relative to the ceramic weight, the pore occurrence rate and pore size are reduced so that the internal electrode connectivity can be controlled to be 90% or more.

Optionally, the dielectric green sheet laminate may be cut so that the first conductive paste layer and the second conductive paste layer are respectively exposed through both cross-sections of the dielectric green sheet laminate.

The ceramic main body is manufactured by sintering the dielectric green sheet laminate at high temperature.

The first external electrode is formed in a cross-section where the first internal electrode of the ceramic main body is exposed, and the second external electrode is formed in a cross-section where the second internal electrode is exposed.

For example, the first external electrode and the second external electrode may be formed by applying conductive paste on the ceramic main body and sintering it, or may be formed by plating. Also, the first external electrode and the second external electrode may be formed by applying conductive paste on a dielectric green sheet laminate and then sintering the conductive paste together with the dielectric green sheet laminate.

In addition, in the multilayer ceramic capacitor manufactured by the method, the grain size of the dielectric material may be formed uniformly. For example, the average size difference of grain sizes respectively measured in the center portion and margin region of the ceramic main body may be 2% or more to 10% or less. For example, grain size may be obtained by calculating the area of the cross-section based on a Transmission electron microscope (TEM) image of the dielectric material and taking the square root of the calculated value. Other methods and/or tools appreciated by one of ordinary skill in the art, even if not described in the present disclosure, may also be used. The average size difference of the grain size may be measured using the Relationship Equation 3 below.

$$DG = \vert ( GC - GD ) / GC \vert \times 100 ( \% ) \qquad [ Relationship Equation 3 ]$$

In here,
DG: average size difference of dielectric grain size
GC: average dielectric grain size of a center portion of the ceramic main body
GD: average dielectric grain size of a margin region

Since products with average size difference of dielectric grain size less than 2% cannot be manufactured, the average size difference of dielectric grain size is formed at least more than 2%. In addition, if the average size difference of the dielectric grain size exceeds 10%, the dispersion of the capacity distribution function increases and control of the process capability index (CPK) is difficult, so performance may be degraded. Accordingly, the breakdown voltage (BDV) may be lowered, and product reliability, such as internal voltage characteristics and accelerated lifespan, may be degraded.

Hereinafter, specific embodiments of the disclosure will be presented.

### [Manufacturing a Multilayer Ceramic Capacitor]

### (Manufacturing Method of Embodiment 1)

A dielectric material paste containing barium titanate (BaTiO₃) powder was applied on a carrier film and then dried to manufacture multiple dielectric green sheets with a thickness of 0.9 μm. The dielectric material paste contained PVB binder with a glass transition temperature (Tg) of 91° C. and a polymerization degree of 1400 at 18 wt % relative to the ceramic weight.

Conductive paste containing nickel was applied on a dielectric green sheet, using the screen printing method.

A dielectric green sheet laminate was manufactured by laminating approximately 700 layers of dielectric green sheets coated with conductive paste and laminating 55 layers of dielectric green sheets not coated with conductive paste on the top and bottom, respectively.

The dielectric green sheet laminate was subjected to isostatic pressing under a pressure condition of 1000 kgf/cm² at 85° C.

After cutting the dielectric green sheet laminate, which had been pressed, into individual chips, a de-binding first process was performed while maintaining it at 340° C. for 71 hours in a nitrogen atmosphere, and a de-binding second process was performed while maintaining it at 650° C. for 6 hours in a nitrogen atmosphere.

Then, sintering was performed at 1130° C. in a reduction atmosphere under oxygen partial pressure of 10-11 atm to 10-10 atm, which is lower than the Ni/NiO equilibrium oxygen partial pressure, in order for the internal electrode not to be oxidated. Next, a multilayer capacitor (L×W×T=1.6 mm×0.8 mm×0.8 mm) was manufactured through processes such as external electrode formation and plating.

### (Manufacturing Method of Embodiment 2)

In the embodiment 1, including PVB binder with a glass transition temperature (Tg) of 92° C. and a polymerization degree of 1900 at 18 wt % relative to the ceramic weight, a dielectric material paste was manufactured. Except for this, a multilayer ceramic capacitor was manufactured using the same method as the embodiment 1.

### (Manufacturing Method of Embodiment 3)

In the embodiment 1, including PVB binder with a glass transition temperature (Tg) of 82° C. and a polymerization degree of 1400 at 18 wt % relative to the ceramic weight, a dielectric material paste was manufactured. Except for this, a multilayer ceramic capacitor was manufactured using the same method as the embodiment 1.

### (Manufacturing Method of Embodiment 4)

In the embodiment 1, including PVB binder with a glass transition temperature (Tg) of 91° C. and a polymerization degree of 2700 at 18 wt % relative to the ceramic weight, a dielectric material paste was manufactured. Except for this, a multilayer ceramic capacitor was manufactured using the same method as the embodiment 1.

### (Manufacturing Method in Comparative Example 1)

In the embodiment 1, including PVB binder with a glass transition temperature (Tg) of 72° C. and a polymerization degree of 3300 at 18 wt % relative to the ceramic weight, a dielectric material paste was manufactured. Except for this, a multilayer ceramic capacitor was manufactured using the same method as the embodiment 1.

### (Manufacturing Method in Comparative Example 2)

In the embodiment 1, including PVB binder with a glass transition temperature (Tg) of 91° C. and a polymerization degree of 1100 at 18 wt % relative to the ceramic weight, a dielectric material paste was manufactured. Except for this, a multilayer ceramic capacitor was manufactured using the same method as the embodiment 1.

### (Manufacturing Method in Comparative Example 3)

In the embodiment 1, including PVB binder with a glass transition temperature (Tg) of 78° C. and a polymerization degree of 1400 at 18 wt % relative to the ceramic weight, a dielectric material paste was manufactured. Except for this, a multilayer ceramic capacitor was manufactured using the same method as the embodiment 1.

### (Manufacturing Method in Comparative Example 4)

In the embodiment 1, including PVB binder with a glass transition temperature (Tg) of 78° C. and a polymerization degree of 4000 at 18 wt % relative to the ceramic weight, a dielectric material paste was manufactured. Except for this, a multilayer ceramic capacitor was manufactured using the same method as the embodiment 1.

### (Manufacturing Method in Comparative Example 5)

In the embodiment 1, including PVB binder with a glass transition temperature (Tg) of 101° C. and a polymerization degree of 2300 at 18 wt % relative to the ceramic weight, a dielectric material paste was manufactured. Except for this, a multilayer ceramic capacitor was manufactured using the same method as the embodiment 1.

### [Breakdown Voltage and Average Failure Time Measurement]

After manufacturing 80 multilayer ceramic capacitors for each of Embodiments 1 to 4 and Comparative Examples 1 to 5, the breakdown voltages (BDV) and average times to failure (MTTF) were measured.

The breakdown voltage (BDV) was measured using an automatic BDV measuring apparatus under a voltage of 200 V, and the average time to failure (MTTF) was measured using an accelerated life-span tester under a temperature of 125° C. and a voltage of 20V.

Table 1 summarizes the measurement results.

TABLE 1

| | Margin | | Internal | Grain | | |
|---|---|---|---|---|---|---|
| | length | Sinking | electrode | size | | |
| | ratio | angle | connectivity | difference | BDV | MTTF |
| | (%) | (°) | (%) | (%) | (V) | (hr) |
| Embodiment 1 | 9.4 | 45 | 95 | 2 | 73 | 6.3 |
| Embodiment 2 | 9 | 35 | 90 | 6 | 67 | 5.5 |
| Embodiment 3 | 8.6 | 30 | 91 | 4 | 71 | 5.8 |
| Embodiment 4 | 10 | 39 | 85 | 10 | 65 | 5.1 |
| Comparative | 8.2 | 25 | 80 | 12 | 32 | 0.4 |
| Example 1 | | | | | | |
| Comparative | 8.1 | 23 | 82 | 3 | 45 | 0.9 |
| Example 2 | | | | | | |
| Comparative | 8 | 22 | 83 | 4 | 41 | 0.8 |
| Example 3 | | | | | | |
| Comparative | 8.3 | 28 | 79 | 14 | 30 | 0.5 |
| Example 4 | | | | | | |
| Comparative | 10.5 | 49 | 78 | 14 | 34 | 1.0 |
| Example 5 | | | | | | |

Referring to Table 1, as shown in Comparative Example 1 to Comparative Example 4, when the margin length ratio is less than 8.6%, the sinking angle is less than 30°, and the internal electrode connectivity is less than 85%, it has been shown that the breakdown voltage (BDV) and the average time to failure (MTTF) significantly decrease. In addition, as shown in Comparative Example 5, when the margin length ratio is greater than 10%, the sinking angle is greater than 45°, and the internal electrode connectivity is less than 85%, it has been shown that the breakdown voltage (BDV) and the average time to failure (MTTF) significantly decrease. Therefore, it was confirmed that the breakdown voltage (BDV) and average time to failure (MTTF) are significantly improved when the margin length ratio was 8.6% or more and 10% or less, the sinking angle was 30° or more and 45° or less, and the internal electrode connectivity was 85% or more. Also, compared to Comparative Example 1, Comparative Example 4, and Comparative Example 5, it has been shown that the difference in grain sizes tends to be generally lower in the embodiments of the present disclosure.

Although preferred embodiments of the present disclosure have been described above, the present disclosure is not limited thereto, various modifications can be implemented within the scope of the patent claims, the detailed description and accompanying drawings, and those obviously fall within the scope of the present disclosure.

What is claimed is:

1. A multilayer ceramic capacitor comprising:
a ceramic main body having a first surface and a second surface facing each other in a first direction, a third surface and a fourth surface facing each other in a second direction and connecting the first surface and the second surface, and a fifth surface and a sixth surface facing each other in a third direction and connecting the first surface and the second surface, the ceramic main body comprising:
a dielectric layer,
a first internal electrode and a second internal electrode stacked in the third direction, the dielectric layer interposing the first internal electrode and the second internal electrode, and
a cover layer positioned on the first internal electrode and the second internal electrode;
a first external electrode disposed outside the ceramic main body and connected to the first internal electrode; and
a second external electrode disposed outside the ceramic main body and connected to the second internal electrode,
wherein an internal electrode connectivity for each of the first internal electrode and the second internal electrode is greater than 85%;
the ceramic main body comprises:
an active region where the first internal electrode and the second internal electrode overlap, and
a margin region that includes:
a first margin region disposed between the first internal electrode and the third surface, and
a second margin region disposed between the first internal electrode and the fourth surface; and
the ceramic main body satisfies the following Condition Equation 1 and Condition Equation 2:
$$8.6 \% \leq ( LM 3 + LM 4 ) / WC \leq 10 \% \qquad [ Condition Equation 1 ]$$
where,
LM3 is a length of first margin region;
LM4 is a length of second margin region; and
WC is a width of ceramic main body, and
$$30 ° \leq θ \leq 45 ° \qquad [ Condition Equation 2 ]$$
where
θ is a sinking angle of the cover layer.

2. The multilayer ceramic capacitor of claim 1, wherein:
an average size difference of dielectric grain sizes in the ceramic main body is 2% to 10%.

3. The multilayer ceramic capacitor of claim 2, wherein:
the average size difference of dielectric grain sizes is calculated by the following Relationship Equation 1;
$$DG = \vert ( GC - GD ) / GC \vert \times 100 ( \% ) \qquad [ Relationship Equation 1 ]$$
where,
DG is the average size difference of dielectric grain sizes;
GC is an average dielectric grain size of a center portion of the ceramic main body; and
GD is an average dielectric grain size of the margin region.

4. The multilayer ceramic capacitor of claim 1, wherein:
at least a part of each of the third surface and the fourth surface is not covered by the first external electrode and the second external electrode.

5. The multilayer ceramic capacitor of claim 1, wherein:
the internal electrode connectivity of the first internal electrode is calculated by the following Relationship Equation 2;
$$EC = ( ( {\sum }_{i = 1}^{n} ti ) / TT ) \times 100 ( \% ) \qquad [ Relationship Equation 2 ]$$
where,
EC is the internal electrode connectivity of the first internal electrode;
n is a number of portions where the first internal electrode is actually connected;
ti is a length of each portion where the first internal electrode is actually connected; and
TT is a total length of the first internal electrode.

6. The multilayer ceramic capacitor of claim 1, wherein:
the cover layer includes a center region positioned above the active region, and a side region positioned outside the center region; and
the sinking angle is an angle between an extension of a surface of the center region and a surface of the side region.

7. The multilayer ceramic capacitor of claim 6, wherein:
the side region is positioned above the margin region.

8. The multilayer ceramic capacitor of claim 7, wherein:
the center region does not overlap the margin region; and
the side region does not overlap the active region.

9. The multilayer ceramic capacitor of claim 6, wherein:
the first surface is in contact with the first external electrode, and the second surface is in contact with the second external electrode; and
the side region comprises a first side region extending from the center region to the first surface, and a second side region extending from the center region to the second surface.

10. The multilayer ceramic capacitor of claim 9, wherein:
the sinking angle comprises a first sinking angle, which is an angle between the extension of the surface of the center region and a surface of the first side region, and a second sinking angle, which is an angle between the extension of the surface of the center region and a surface of the second side region; and
both the first sinking angle and the second sinking angle satisfy the Condition Equation 2.

11. The multilayer ceramic capacitor of claim 1, wherein:
the first internal electrode includes a plurality of first internal electrodes,
the second internal electrode includes a plurality of second internal electrodes, and
a length of the active region is the maximum value among lengths of portions where the plurality of first internal electrodes and the plurality of second internal electrodes overlap each other.

12. The multilayer ceramic capacitor of claim 1, wherein:
the first internal electrode includes a plurality of first internal electrodes,
the second internal electrode includes a plurality of second internal electrodes, and
a length of the active region is a minimum value among lengths of portions where the plurality of first internal electrodes and the plurality of second internal electrodes overlap each other.

13. The multilayer ceramic capacitor of claim 1, wherein:
the first internal electrode includes a plurality of first internal electrodes,
the second internal electrode includes a plurality of second internal electrodes, and
a length of the active region is an arithmetic average value of at least two lengths among lengths of portions where the plurality of first internal electrodes and the plurality of second internal electrodes overlap each other.

14. The multilayer ceramic capacitor of claim 1, wherein:
a length of the first margin region is a maximum value among lengths measured from the active region to the first external electrode in a direction parallel to the first internal electrode; and
a length of the second margin region is the maximum value among lengths measured from the active region to the second external electrode in the direction parallel to the first internal electrode.

15. The multilayer ceramic capacitor of claim 1, wherein:
a length of the first margin region is a minimum value among lengths measured from the active region to the first external electrode in a direction parallel to the first internal electrode; and
a length of the second margin region is a minimum value among lengths measured from the active region to the second external electrode in the direction parallel to the first internal electrode.

16. The multilayer ceramic capacitor of claim 1, wherein:
a length of the first margin region is an arithmetic average value of at least two lengths among lengths measured from the active region to the first external electrode in a direction parallel to the first internal electrode; and
a length of the second margin region is an arithmetic average value of at least two lengths among lengths measured from the active region to the second external electrode in a direction parallel to the first internal electrode.

17. A method of manufacturing the multilayer ceramic capacitor of claim 1, comprising:
laminating dielectric green sheets to form a laminate, wherein the dielectric green sheets include a ceramic and polyvinyl butyral, and the polyvinyl butyral has a glass transition temperature of 80° C. or more and 90° C. or less, and a polymerization degree of 1,300 or more and 3,000 or less.

18. The method of claim 17, wherein:
the dielectric green sheets include the polyvinyl butyral in an amount of 10 wt % or more and 30 wt % or less, based on a total weight of the ceramic.

19. The method of claim 17, further comprising:
pressing the laminate to form the ceramic main body.
